(19) United States
(12) Patent Application Publication
(10) Pub. No.: US 2004/0084557 A1
(43) Pub. Date: May 6, 2004

(54) Crusher machine

(76) Inventors: Paul Douglas, Swadlincote (GB); Terence Bratton, Swadlincote (GB)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/614,467

(22) Filed: Jul. 7, 2003

(30) Foreign Application Priority Data
Jul. 4, 2002 (GB) 0215441.7

(51) Int. Cl. B02C 21/02

(52) U.S. Cl. 241/101.76

(57) ABSTRACT

A crusher (10) having a chassis (11) on which a crushing chamber (23) is mounted and having an upper loading opening (26) to receive crushable material and a lower discharge opening (27) through which gravity discharge of crushed material can take place. In the event of material becoming jammed in the crushing chamber (23), an unjamming vehicle (15) having rock breaker attachment (17, 18) is operated, which is clamped to a vehicle support platform (13) mounted on the chassis (11) and which is located near to the crushing chamber (23) so that the rock breaker attachment (17, 18) can reach into the chamber (23) to engage with and to break-up the jammed material.

This invention relates to a crusher machine for use in crushing rock or other crushable material, and having a crushing chamber, a loading opening to the chamber for receiving crushable material, and a discharge opening for discharging crushed material from the chamber, and a crushing device arranged in the crushing chamber and operative to crush material between the jaws.

### BACKGROUND TO INVENTION

Crushers are used in a quarry environment in order to breakdown excavated rock to a smaller size range, or range of sizes e.g. to form hardcore for use in forming a sub-base for roads and buildings; or to form, ballast gravel or sand.

The crushing chamber may have a pair of crusher jaws, and usually comprise a fixed jaw and a cooperating movable jaw which define a receiving space therebetween for crushable material. An eccentric dive mechanism is coupled with the movable jaw and is operative to cause the movable jaw to rock back and forth relative to the fixed jaw in order to exert a cycle of operation involving crushing action and then relieving the pressure on the material between the fixed and movable jaws, followed by further crushing action and so on.

Although the jaws are designed and manufactured to be of robust construction (bearing in mind the substantial impacts and other loads applied in service to the jaws), with existing equipment it does happen from time to time that material becomes jammed or blocked between the jaws, and this requires the crusher operation to be stopped and for the blocked material to be moved before work can resume.

Other designs of crushing chamber include “cone-type” crusher devices, and such chambers also may be liable to become jammed with material, from time to time, and which has to be removed.

In order to clear the jammed material, it is usual practice to bring a large excavator alongside the crusher, and to employ a jackhammer attachment on the excavator to break up the jammed material in the crushing chamber, and which then falls down through the discharge opening under the action of gravity. This then enables the operation of the crusher to re-resume.

The excavator necessarily needs to be of substantial size, so that the jackhammer attachment can be raised above the loading opening to the crushing chamber and then lowered into engagement with the jammed material. Also, of course, the excavator has to be manoeuvred to a suitable position alongside the crusher.

### SUMMARY OF INVENTION

The invention therefore seeks to simplify the procedures involved in clearing jammed material in the crushing chamber, and while utilising a smaller size of ancillary equipment than present use of large excavators.

According to one aspect of the invention there is provided a crusher machine which comprises:

a chassis;

a crushing chamber mounted on the chassis and having an upper loading opening for receiving crushable material and a lower discharge opening through which gravity discharge of crushed material can take place;

a vehicle support platform mounted directly or indirectly on the chassis and onto which a small vehicle can be loaded, said vehicle having a rock breaker attachment; and

clamps engageable with the vehicle in order to clamp the vehicle to the platform:

in which the platform is located near to the crushing chamber so that, when the vehicle is clamped to the platform, the rock breaker attachment can reach into the chamber to engage with and to break up any jammed material trapped in the crushing chamber.

The invention therefore, by a simple provision of a support platform at a convenient position on the crusher machine, enables blockages of material in the crushing chamber to be freed without need to deploy and operate a large excavator located on the ground alongside the crusher. Instead, a small vehicle e.g. a tracked mini excavator, can be permanently or semi-permanently mounted on the platform (by clamping the tracks to the platform) for use whenever crushing chamber blocking occurs.

However, in the event that independent operation of the mini excavator may be required, it is a simple matter to unclamp the tracks and lift the excavator off the platform and place it on the ground so that it can then propel itself to wherever it is required, to operate independently of the crusher.

The crusher may be self-propelled, to enable it to be manoeuvred to a required position on site, preferably by means of a pair of endless tracks, and which are lifted out of engagement with the ground when crushing operations are required.

The tracks may be capable of being raised and lowered relative to the chassis, or a pair of lowerable support legs may be mounted on the chassis which operate to raise or lower the entire crusher machine.

According to a further aspect of the invention there is provided a method of freeing jammed material located in a crushing chamber of a crusher machine, said machine having a support platform onto which an un-jamming vehicle can be mounted, said method comprising:

loading a small vehicle onto the support platform, and clamping the vehicle to the platform, said vehicle having a rock breaker attachment;

extending the rock breaker attachment of the vehicle so as to enter the crushing chamber; and

engaging the working part of the rock breaker attachment with the jammed material and operating the attachment in order to break up the jammed material which then falls downwardly under gravity from the crushing chamber.

A preferred embodiment of crusher machine according to the invention will now be described in detail, by way of example only, with reference to the accompanying drawings.

### BRIEF DESCRIPTION OF DRAWINGS

FIG. 1 is a side view of the crusher machine raised on support legs so as to be capable of carrying out crushing operations; and,

FIG. 2 is a schematic illustration of a fixed and movable jaw of the crushing chamber of the machine shown in FIG. 1.

### DESCRIPTION OF PREFERRED EMBODIMENT

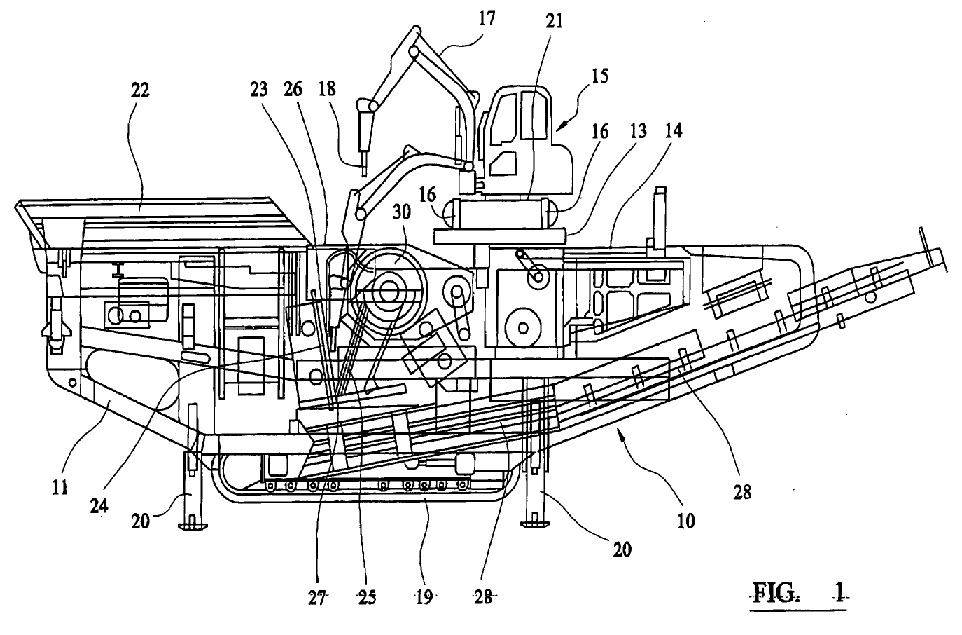

Referring to FIG. 1 of the drawings, a crusher machine according to the invention is designated generally by reference 10 and has a main frame or chassis 11, and on the chassis are mounted usual supply hoppers 22 for storing crushable material, a crushing chamber 23 having a pair of cooperating crushing jaws 24, 25, a loading opening 26 leading to the crushing chamber 23 for receiving crushable material, and a lower discharge opening 27 from which crushed material can be discharged under gravity, to fall on one or more discharge conveyors or elevators 28, which discharge the crushed material to any required stockpile.

All of these components of rock crushers are well known, and detailed description thereof is not considered necessary.

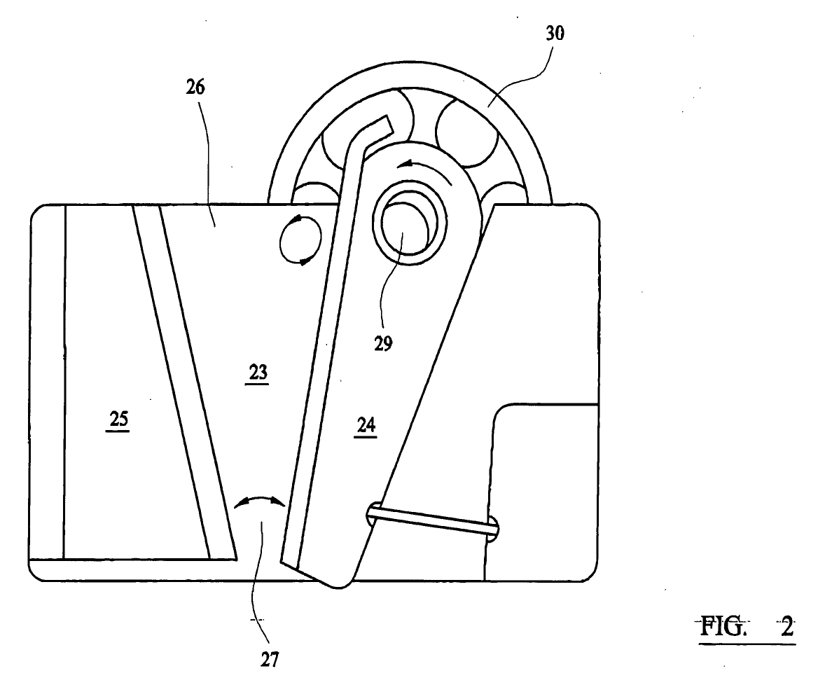

The crushing chamber 23 is shown schematically in FIG. 2, having upper loading opening 26 and lower discharge opening 27, and the pair of crusher jaws 24, 25 is arranged in the crushing chamber 12 and operative to crush material therebetween. The jaw 25 is a fixed jaw, and the jaw 24 is a movable jaw which is movable to and fro under the operation of an eccentric drive mechanism 29 and flywheel 30, to carry out cycles of crushing and relieving action on the material which falls into the space between the jaws.

It happens that, from time to time, crushable material becomes jammed or trapped between the jaws, and the operation of the crusher 10 has to be interrupted, rather than risk doing permanent damage to the operating components. There will now be described a simple attachment to the chassis 11, directly or indirectly, whereby blockages of material in the crushing chamber 23 can be freed without need to deploy and operate a large excavator standing on the ground alongside the crusher 10.

A vehicle support platform 13 is mounted on the upper superstructure 14 of the machine, supported by the chassis 11, and any small vehicle, preferably a tracked mini excavator 15 having endless tracks 21, can be permanently or semi-permanently mounted on the platform 13, for use whenever crushing chamber blocking occurs.

The tracked vehicle 15 is held down or clamped to the platform 13 by use of suitable clamps 16, (after the excavator 15 has been loaded onto the platform 13) and which hold down the tracks 21 of the vehicle on the platform 13.

The excavator 15 is provided with a rock breaker attachment 17, having a working rock breaker tip 18 and which can easily be lowered into the crushing chamber 23 and into engagement with the jammed material. Operation of the rock breaker attachment 17 then breaks up the jammed material, which is then able to fall down under gravity through the lower discharge opening 27 and onto the discharge conveyors or elevators 28 to be transferred to stockpile.

The platform 13 is located close to the crushing chamber 23, and it is a simple matter for the excavator 15 to be operated in order to deploy the rock breaker attachment to enter the crushing chamber and then carry out freeing of the jammed material.

A mini excavator 15 is more than sufficient to carry out the un-jamming operation, and which is a considerable improvement over existing use of large scale excavators, which hitherto have been used in order to clear jammed materials. However, other small vehicles may be utilised, provided they have a rock breaker attachment and can be clamped to the platform.

In the event that independent operation of the mini excavator 15 may be required, it is a simple matter to unclamp the tracks 21 and lift the excavator 15 off the platform and place it onto the ground, so that it can then propel itself to wherever it is required to be operated independently of the crusher.

The crusher 10 is self-propelled, to enable it to be manoeuvred to a required operating site, and has a pair of endless tracks 19. These tracks are shown in FIG. 1 raised above the ground, and in the illustrated embodiment this is achieved by lowering a set of lowerable support legs 20, which are able to raise and lower the entire crusher 10.

Alternatively, the tracks 19 may be arranged so as to be capable of being raised and lowered relative to the chassis 11.

Although not shown, the invention may also be applied to other types of crushing machine having different arrangements of crushing device in the crushing chamber (different from fixed and movable crusher jaws as shown in the preferred embodiment). By way of example only, the crushing chamber may include a crushing device in the form of a “cone-type” crusher.

We claim:

1. A crusher machine which comprises:
a chassis;
a crushing chamber mounted on the chassis and having an upper loading opening for receiving crushable material and a lower discharge opening through which gravity discharge of crushed material can take place;
a vehicle support platform mounted directly or indirectly on the chassis and onto which a small vehicle can be loaded, said vehicle having a rock breaker attachment; and
clamps which are engageable with the tracks of the vehicle in order to clamp the vehicle to the platform;
in which the platform is located near to the crushing chamber so that, when the vehicle is clamped to the platform, the rock breaker attachment can reach into the chamber to engage with and to break up any jammed material which becomes trapped in the chamber.

2. A crusher machine according to claim 1, in which the crushing chamber includes a pair of crusher jaws arranged in the crushing chamber and operative to crush material therebetween.

3. A crusher machine according to claim 2, in which one of the crusher jaws is a fixed jaw, and the other jaw is a movable jaw operated by an eccentric drive mechanism.

4. A crusher machine according to claim 2, in which the crusher machine is self-propelled via a pair of endless tracks.

5. A crusher machine according to claim 4, in which a set of lowerable legs is mounted on the chassis, and is operative to raise and lower the entire machine.

6. A crusher machine according to claim 4, in which the endless tracks can be raised or lowered relative to the chassis.

7. A crusher machine according to claim 1, in combination with a tracked vehicle (15) which can be clamped to the platform via clamps (16) which are engageable with the tracks of the vehicle.

7. A method of freeing jammed material located in a crushing chamber (23) of a crusher machine (10), said machine having a vehicle support platform (13) onto which an un-jamming vehicle can be mounted, said method comprising:
loading a small vehicle (15) onto the landing platform (13), and clamping the vehicle to the platform, said vehicle having a rock breaker attachment (17, 18);
extending the rock breaker attachment (17, 18) of the vehicle so as to enter the crushing chamber (23); and
engaging the working part (18) of the rock breaker attachment with the jammed material and operating the attachment in order to break up the jammed material which then falls downwardly under gravity from the crushing chamber.
